(19) United States
(12) Patent Application Publication
(10) Pub. No.: US 2003/0035407 A1
(43) Pub. Date: Feb. 20, 2003

(54) Packet retransmission in wireless packet data networks

(76) Inventors: Rangaprasad Govindarajan, Plano, TX (US); Shridhar Krishnamurthy, Coppell, TX (US); Jogen Pathak, Dallas, TX (US)

Correspondence Address: R. Scott Rhoades, Strasburger & Price, L.L.P., Suite 4300, 901 Main Street, Dallas, TX, 75202-3794, US

(21) Appl. No.: 09/884,663

(22) Filed: Jun. 19, 2001

Related U.S. Application Data
(63) Continuation-in-part of application No. 09/839,830, filed on Apr. 19, 2001.
(63) Continuation-in-part of application No. 09/718,723, filed on Nov. 22, 2000.
(60) Provisional application No. 60/251,929, filed on Dec. 7, 2000.
(60) Provisional application No. 60/192,169, filed on Mar. 27, 2000.

(51) Int. Cl. H04B 7/14; H04L 12/28; H04L 12/56

(52) U.S. Cl. 370/349; 370/394

(57) ABSTRACT

A system, method, and apparatus for transmitting packet data over a wireless network to a mobile station is presented herein. Packet data are received at a wireless content switch which is interposed between a wireline network and the mobile station. The wireless content switch is equipped to detect lost packets, lost acknowledgments, and take appropriate remedial action, without invoking the congestion control and avoidance mechanisms of the transmission control protocol.

### FIELD

The present application is related to wireless packet data networks, and more particularly to packet retransmission in wireless packet data networks.

### BACKGROUND

Wireless networks which were originally designed for wireless telephone services are being adapted for wireless data services as well. The wireless networks are adapted for wireless data services by linking the wireless network to the preexisting wired data network. Wireless packet data protocols such as General Packet Radio Service (GPRS) and EDGE were developed to facilitate the transmission of data packets over the wireless network.

The most common wired data network is the internet. The internet is a global network connecting computers from government agencies, educational institutions, the military, and businesses from around the world. Data is transmitted over the internet using data packets. The data packets are sent from a sender to a recipient over any one of a number of network connections between the sender and recipient. Unlike a switched network, no dedicated connection between the sender and recipient is established. In contrast, the packets are sent from the sender with an address associated with the recipient, such as an Internet Protocol address (IP address) over any one of a number of available paths which are formed between the sender and recipient by the internet.

Due to the lack of a dedicated path between the recipient and the sender, the requisite time of transmission can vary from packet to packet. Additionally, during periods of high congestion, data packets can also be lost. The foregoing considerations necessitate a means of providing the sender with a confirmation that the transmitted data packets are received. The Transmission Control Protocol (TCP) provides for the use of acknowledgement messages between the recipient and the sender, responsive to receipt of a data packet.

TCP initially causes the transmission rate to ramp-up in a sliding window at the beginning of a packet flow, which is called the slow-start mode. The rate is continuously increased until there is a loss or time-out of the packet receipt acknowledgement message. TCP then “backs off”, decreasing the transmission window size, and then retransmits the lost packets in the proper order at a significantly slower rate. TCP will then slowly increase the transmission rate in a linear fashion, which is called the congestion-avoidance mode. TCP assumes that packet losses are due to congestion and implements “congestion avoidance” at the source of the information.

As noted above, TCP assumes that lost packets are due to network congestion. In wired networks, which are characterized by low bit error rates, the assumption is accurate. However, wireless networks are characterized by comparatively higher bit error rates, limited bandwidth, radio interference, and intermittent hand-offs, that are different from wired networks. The higher bit error rates, radio interference, and intermittent hand-offs cause more packet losses. The assumption that packet losses are due to congestion becomes inaccurate.

In the presence of the high bit error rates and intermittent connectivity characteristic of wireless links, TCP reacts to packet losses in the same manner as in the wired environment. The transmission window size is lowered before retransmitting packets and congestion control and avoidance mechanisms are invoked. The foregoing measures result in an unnecessary reduction in the wireless link's bandwidth utilization, thereby causing a significant degradation in performance in the form of poor throughput and very high interactive delays.

Modifications to the TCP protocol are often unfeasible because of the necessary changes that would have to be made to the preexisting wired network. A number of proposals have been made to alleviate the aforementioned degradation in performance, such as using a split connection, fast-retransmit, and caching packets at the base station.

The Indirect-TCP (I-TCP) uses a split connection approach which involves splitting a TCP connection between a fixed and mobile host into two separate connections at the base station. The first connection is a TCP connection between the base station and the fixed host, while the second is between the base station and the mobile station. Because the second connection is a one-hop wireless link, a more optimized wireless link-specific protocol is used. Although I-TCP advantageously separates flow and congestion control of the wireless link from that of the fixed network, there are also a number of drawbacks. For example, I-TCP acknowledgments and semantics are not end-to-end. Additionally, application running on the mobile station have to be relinked with the I-TCP library and need to use special I-TCP socket system calls. As well, packets need to go through the TCP protocol stack and incur the associated overhead four times - once at the sender, twice at the base station, and once at the receiver.

The fast retransmit approach addresses the issue of TCP performance when communication resumes after a handoff. Problems associated with handoffs are mitigated by having the mobile station send a certain threshold number of duplicate acknowledgments to the sender, causing the sender to immediately reduce the window size and retransmit packets starting from the first missing packet. The main drawback of the fast retransmit approach is that only problems associated with handoffs are addressed.

Balakrishnan, et. al., in “Improving TCP/IP Performance over Wireless Network”, proceedings 1st ACM International Conference on Mobile Computing and Networking, November 1995, propose a transport protocol wherein packets are cached at the base station. Lost packets are retransmitted locally over the wireless link, thereby hiding packet loss over the wireless link from the fixed host. However, the transport protocol requires modifications of the network layer software at the base station and the mobile station.

Accordingly, it would be desirable to alleviate the performance degradation brought on by TCP congestion control and avoidance mechanisms in response to lost data packets over wireless links in a seamless manner with minimal modifications to the preexisting infrastructure.

### SUMMARY

Presented herein is a system and method for transmitting packet data over a wireless network to a mobile station. A wireless content switch is interposed between the wireline network and the mobile station which monitors the transmissions and detects lost data packets, and lost acknowledgments based on the received data packets and acknowledgments.

The wireless content switch stores the data packets, prior to transmission to the mobile station. When lost data packet conditions are detected, the wireless content switch takes remedial actions without invoking the congestion control and avoidance schemes of the Transmission Control Protocol (TCP), and therefore avoiding the performance degradation associated therewith.

### BRIEF DESCRIPTION OF THE DRAWINGS

FIG. 1 is a block diagram of an exemplary data communication system;

FIG. 1A is a block diagram of an exemplary wireless content switch;

FIG. 2 is a flow diagram describing the operation of the wireless content switch;

FIG. 2A is a flow diagram describing the determination of whether a received packet is in sequential order by the wireless content switch;

FIG. 3 is a signal flow diagram describing the operation of the system, wherein data packets are transmitted from content source to mobile station;

FIG. 4 is a signal flow diagram describing the operation of the system wherein a data packet is lost in the wired network;

FIG. 5 is a signal flow diagram describing the operation of the system wherein a data packet is lost in the wireless air interface;

FIG. 6 is a signal flow diagram describing the operation of the system wherein a lower order data packet is received;

FIG. 6A is a signal flow diagram describing the operation of the system wherein the radio link is down;

FIG. 6B is a signal flow diagram describing the operation of the system wherein the radio link is found to be operational; and

FIG. 6C is a signal flow diagram describing the operation of the wireless content switch wherein an acknowledgment is received.

### DETAILED DESCRIPTION OF THE DRAWINGS

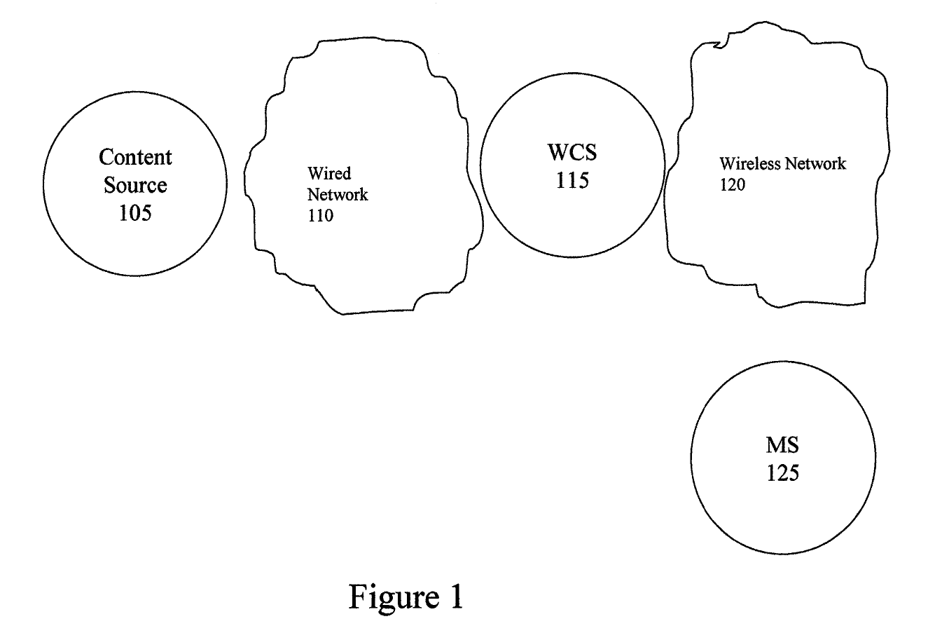

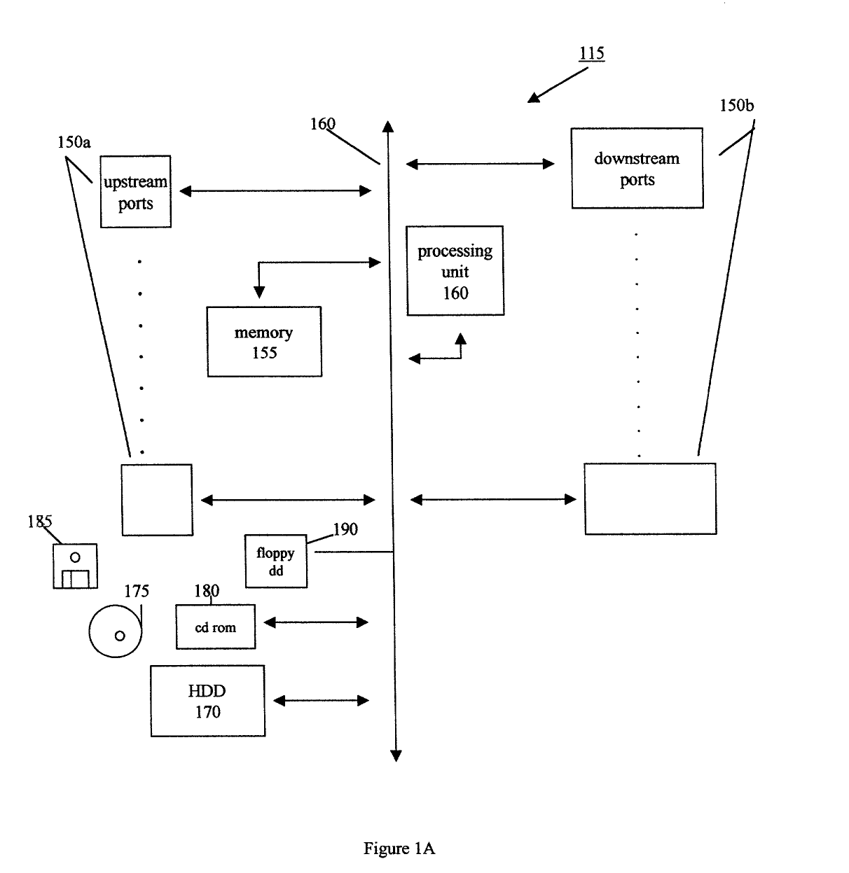

Referring now to FIG. 1, there is illustrated a conceptual diagram of a communication system, referenced generally by the numeric designation 100, for sending data packets from content source 105 to a mobile station 125. The content source 105 is a server providing information which can comprise, for example, a web server, email server, ftp server, database server, streaming audio/video server, or an application server.

Information from the content source 105 is transmitted in the form of numbered data packets over a wired network 110, wherein each data packet is associated with a packet number. The wired network 110 is a packet data wireline communication system which can comprise, for example, a local area network, a wide area network, or the Internet. The wired network 110 transmits the data packets to a wireless network 120 associated with the mobile station 125 via a wireless content switch 115.

The wireless network 120 comprises any communication network which can transmit packet data over a wireless air interface. For example, the wireless network 120 can comprise cellular telephone networks, such as the Global System for Mobile Communications (GSM) or Personal Communication System (PCS), equipped to transmit packet data in accordance with the General Packet Radio Service (GPRS) or EDGE protocols. The wireless network 120 transmits the packet data over the wireless air interface to the mobile station 125.

The wireless content switch 115 receives GPRS tunneling protocol format packet data and can determine additional processing that may be required based upon the mobile station 125, and the type of content in the packet, priority data, quality of service data, multicasting functionality, or other suitable functions.

The wired network 110 uses the Transmission Control Protocol (TCP) which provides for the use of acknowledgement messages to the content source 105, responsive to receipt of the data packet. Upon receipt of the data packets, acknowledgments are sent which indicate the last contiguous data packet received. For example, wherein data packets P(1) . . . P(N) are received, followed by P(N+2) . . . P(N+T), wherein T is a predetermined threshold, an acknowledgment indicating P(N) will be sent responsive to receipt of P(N+T). The acknowledgment indicating P(N) after transmission of P(N+T) is considered duplicative acknowledgment. As noted above, TCP assumes that lost packets are due to network congestion. In the wired network 110, which is characterized by low bit error rates, the assumption is accurate. However, the air interface between the mobile station 125 and the wireless network 120 is characterized by comparatively higher bit error rates, limited bandwidth, radio interference, and intermittent hand-offs. The higher bit error rates, radio interference, and intermittent hand-offs cause more packet losses. The assumption that packet losses are due to congestion becomes inaccurate.

The wireless content switch 115 receives the data packets sent from the content source 105 and forwards the data packet to the mobile station 125. Prior to forwarding the packet to the mobile station 125, the wireless content switch 115 stores the data packet. When the mobile station 125 receives data packets, the acknowledgments transmitted from the mobile station 125 are received by the wireless content switch 115.

As noted above, the acknowledgments transmitted from the mobile station 125 are indicative of the last contiguous packet received, thereat. Therefore, the receipt by the wireless content switch 115 of duplicative acknowledgments are indicative of lost packets between the wireless air interface and the mobile station 125.

Responsive thereto, the wireless content switch 115 can retransmit the missing data packet to the mobile station 125. Upon receipt of the missing packet, the mobile station 125 transmits an acknowledgment to the wireless content switch 115. The wireless content switch 115 then forwards the acknowledgment to the content source 105. In the foregoing manner, TCP congestion control and avoidance is prevented from occurring due to the loss of a data packet over the wireless air interface.

Referring now to FIG. 1A, there is illustrated a block diagram of an exemplary wireless content switch 115. The wireless content switch 115 includes any number of upstream ports 150a and downstream ports 150b. The upstream ports 150a facilitate connection of the wireless content switch 115 towards the content source 105 via a trunk line, such as, for example, a T1, E1, or an Ethernet connection, to name a few. Connection of the wireless content switch 115 towards the content source 105 via the upstream port 150a permits, at the upstream port 150a, receipt and transmission of data packets, acknowledgments, and other signals to and from content source 105.

Similarly, the downstream ports 150b facilitate connection of the wireless content switch 115 towards the mobile station 125 via a trunk line. Connection of the wireless content switch 115 towards the mobile station 125 via the downstream port 150b permits, at the downstream port 150b, receipt and transmission of data packets, acknowledgments, and other signals to and from content source 105.

The wireless content switch 115 also includes memory 155 wherein packets received from the upstream port 150a are stored. In one embodiment, the memory 155 can comprise Shared Dynamic Random Access Memory (SDRAM). Packets received from upstream port 150a are transmitted along a bus 160 for storage into the memory 155. Data packets stored in the memory 155 are transmitted by forwarding the data packet from the memory 155 to the downstream port 150b via bus 160.

The memory 155 can also store executable instructions for execution by a processing unit 165. Until required by the processing unit 165, the instructions may be stored in another memory, for example in a hard disk drive 170, or in a removable memory such as an optical disk 175 for eventual use in a compact disk read only memory (CD-ROM) drive 180 or a floppy disk 185 for eventual use in a floppy disk drive 190.

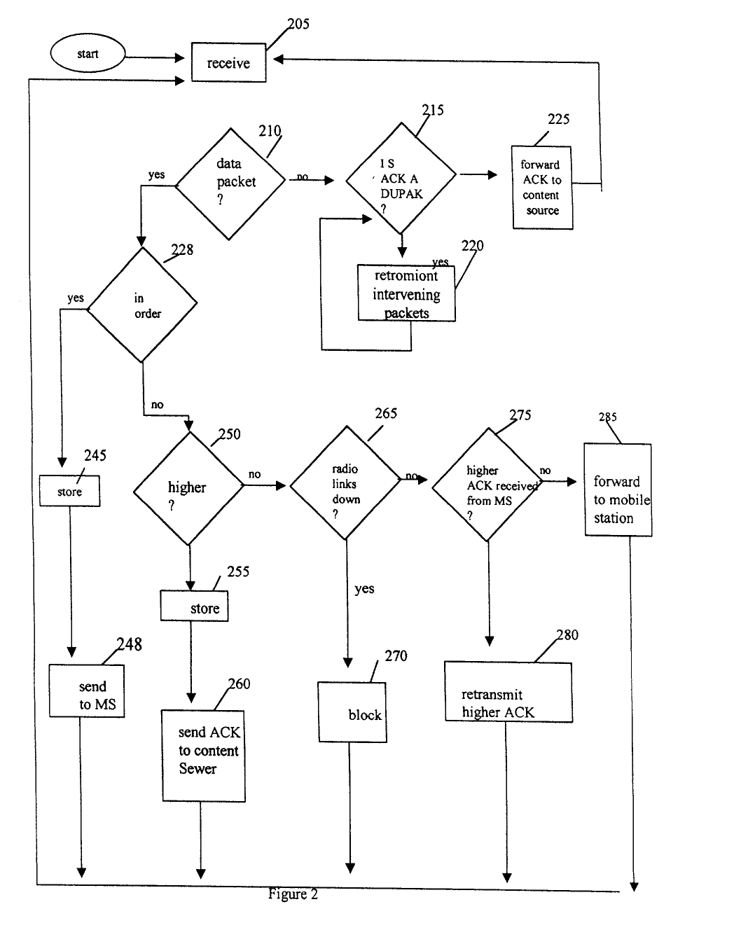

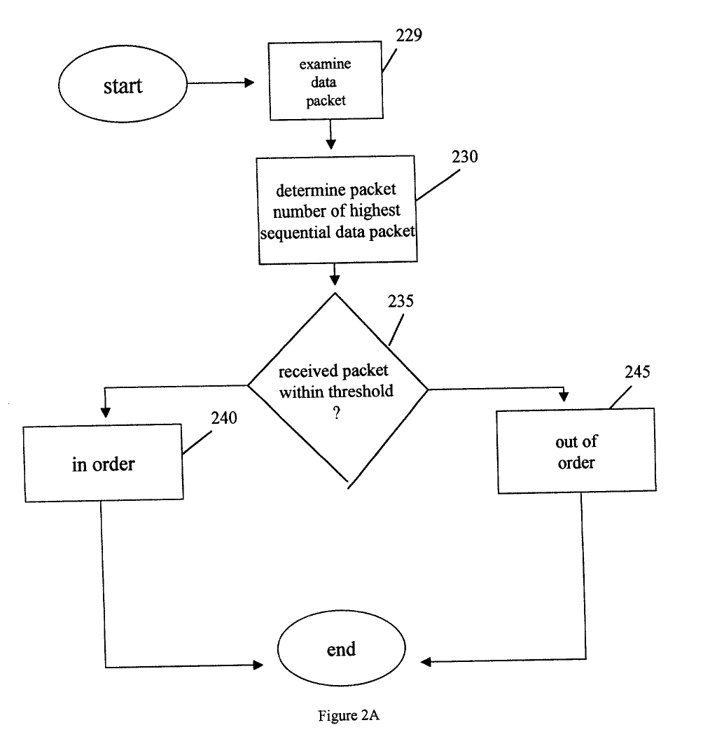

Referring now to FIG. 2, there is illustrated a flow diagram describing the operation of the wireless content switch, responsive to receiving a signal at a port 150 (step 205). At step 210, a determination is made whether the signal is an acknowledgment or a data packet. Wherein the received signal is an acknowledgment during step 210, a determination is made whether the acknowledgment is a duplicated acknowledgment or not (step 215).

Wherein the acknowledgment, e.g., A(I) was received before (known as a “duplicate acknowledgment”), the foregoing condition is indicative that data packets transmitted to the mobile station 125 after data packet P(I) were lost. Therefore, the packets after P(I) must be retransmitted. Accordingly, wherein the acknowledgment is a duplicate acknowledgment during step 215, the wireless content switch 115 retransmits (step 220) the intervening packets. As noted above, the wireless content switch 115 stores data packets in memory 155, prior to transmission to the wireless data network 120. Therefore, the wireless content switch can retrieve the intervening data packets from memory 155 and retransmit them via downstream port 150b. Wherein the acknowledgment is not a duplicate acknowledgment during step 215, the acknowledgment is forwarded to the content source 105 via upstream port 150a (step 225).

Wherein the signal received during step 210 is a data packet, a determination is made whether the packet is in sequential order (step 228). Referring now to FIG. 2A, there is illustrated a flow diagram describing the operation of the wireless content switch 115 in determining whether the received data packet is in sequential order. At step 229, the received data packet is examined. By examining the data packet, the wireless content switch 115 can determine a packet number associated with the received data packet. The packet number is related to the sequential order of the data packet in a sequence of data packets. The wireless content switch 115 then determines (step 230) the packet number of the highest sequential data packet and compares (step 235) the packet number to the received data packet number.

It is noted that the internet does not always deliver data packets in sequence. While a given packet, K+1, may be received prior to packet K, the foregoing condition may is not necessarily due to the fact that packet K is lost or even excessively delayed. However, wherein a packet K+T is received prior to packet K, wherein T represents a predetermined threshold, there is a great likelihood that packet K is lost or excessively delayed between the content source 105 and the internet content switch 115. Accordingly, during step 235, wherein the packet number of the received data packet is within a predetermined threshold, T, of the packet number of highest sequential data packet, a determination (step 240) is made that the packet is received in order. However, wherein the packet number of the received data packet is beyond the predetermined threshold, T, a determination (step 245) is made that the data packet is received out of order.

Referring again to FIG. 2, wherein the data packet is in sequential order, the data packet is stored by the wireless content switch 115 in memory 155 (step 246) and sent to the mobile station 125 via downstream port 150b (step 248). Wherein the data packet is not in sequential order, a determination is made whether the data packet is in higher sequential order or in lower sequential order (step 250). Wherein the data packet is in higher sequential order during step 250, the foregoing is indicative of data packets lost between the content source 105 and the wireless content switch 115. Therefore, the intervening data packets must be retransmitted to the wireless content source 115. Accordingly, the wireless content switch 115 stores (step 255) the data packets in memory 155 and transmits an acknowledgment via upstream port 150a (step 260) to the content source 105. The acknowledgment transmitted to the content source 105 indicates the last contiguous data packet received, thereby causing the content source 105 to retransmit the missing data packets.

Wherein the received data packets are in lower sequential order, the foregoing is indicative that the content source 105 has timed out prior to receive appropriate acknowledgments. The wireless content switch 115 examines the wireless radio link conditions and determines (step 265) whether the radio link is down. Whether the radio link is down or not can be determined by, for example, using a handshake signal. Wherein the radio link is down, the received data packets are blocked (step 270).

Wherein the radio link is not down during step 265, a determination is made whether the wireless content switch 115 has received an acknowledgment of a higher packet number (step 275). Wherein an acknowledgment of a higher data packet has been received, the foregoing is indicative that an acknowledgment of a lower number data packet from the mobile station 125 has been lost. Accordingly, the acknowledgment of the higher data packet is retransmitted to the content source 105 (step 280). Wherein an acknowledgment of a higher data packet number has not been received, the data packets are retransmitted from memory 155 (step 285) to the mobile station 125.

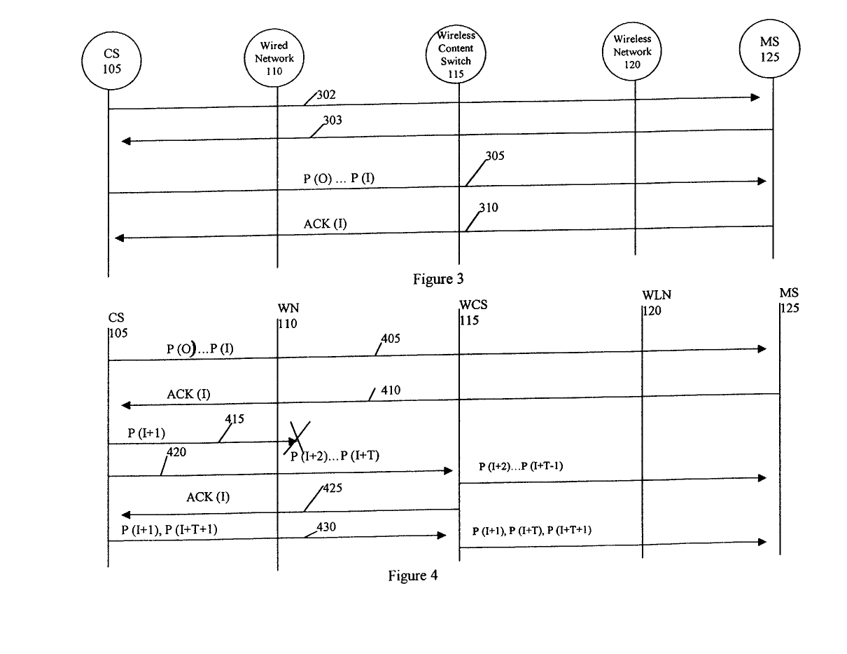

The operation of the wireless content switch 115 is now described in certain exemplary scenarios. Referring now to FIG. 3, there is illustrated a signal flow diagram describing acknowledgment of sequential packets wherein the packets are received in order. Initially, the content source 105 transmits a setup signal 302 to the mobile station 125. The mobile station 125 then transmits a signal 303 containing a mobile station 125 identifier.

The content source 105 transmits information in the form of sequential data packets, wherein each data packet is associated with a particular sequential number, e.g., P(0) . . . P(I). The data packets are transmitted from the content sources 105 via the wired network 110 (signal 305), wireless content switch 115, and wireless network 120 to the mobile station 125. Upon receipt of a particular data packet, an acknowledgment is transmitted from the mobile station 125 which indicates the last contiguous packet. Therefore, wherein data packets P(0) . . . P(I) are received at the mobile station 125, responsive to receipt of data packet P(I), the mobile station transmits an acknowledgment, ACK(I) (signal 310).

Referring now to FIG. 4, there is illustrated a signal flow diagram describing the operation of the system, wherein a data packet is lost in the wired network 110. The content source 105 transmits data packets P(0) . . . P(I) to the mobile station 125 (signals 405), and the mobile station 125 transmits acknowledgments (signals 410) to the content source 105. The content source 105 transmits data packets P(I+1) (signal 415) and P(I+2) . . . P(I+T) (signal 420) to wireless content switch 115 via upstream port 150a, wherein data packet P(I+1) is lost in the wired network 110. Responsive to receipt of data packet P(I+2) . . . P(I+T) at the wireless content switch 115, the wireless content switch 115 detects that data packet P(I+1) is lost. The wireless content switch 115 transmits an acknowledgment ACK(I) (signal 425) via upstream port 150a indicating that data packet P(I) was the last contiguous packet received.

Additionally, the wireless content switch 115, and withholds transmission of data packet P(I+T) towards the mobile station 125. Responsive to receiving ACK(I), the content source 105, retransmits data packet P(I) with data packet P(I+T+1) (signal 430). Upon receipt of data packets P(I), P(I+T+1), the wireless content switch transmits data packets P(I+1), P(I+T), and P(I+T+1) (signals 435) to the mobile station 125 via downstream port 150a. Upon receipt of data packets P(I+1), P(I+2), and P(I+3), the mobile station 125 transmits acknowledgment (signal 440), ACK(I+3) indicating that every packet until P(I+3) has been received.

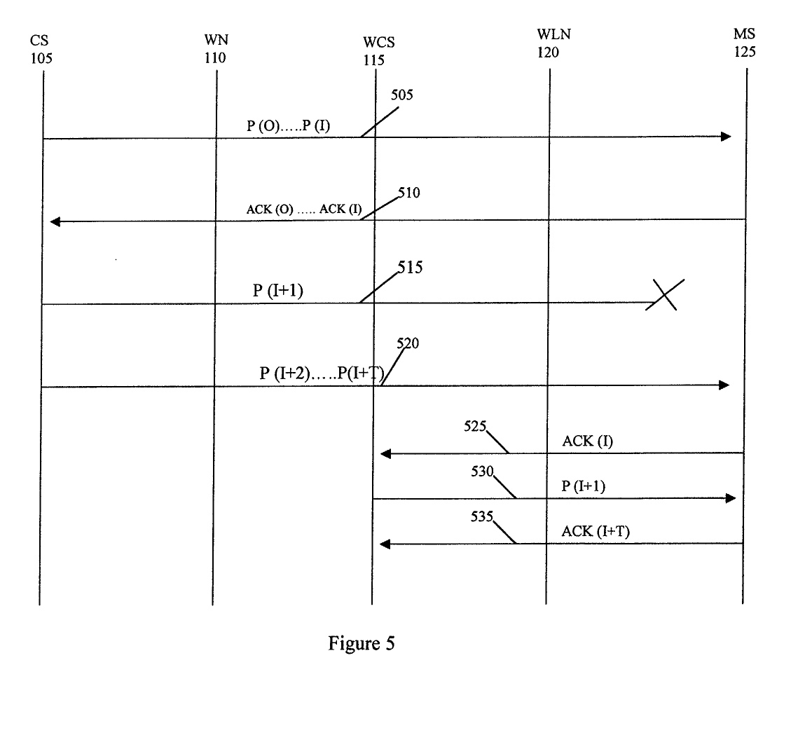

Referring now to FIG. 5, there is illustrated a signal flow diagram describing the operation of the system wherein a data packet is lost in wireless air interface between the wireless network 120 and the mobile station 125. The content source 105 transmits data packets P(0) . . . P(I) to the mobile station 125 (signals 505), and the mobile station 125 transmits acknowledgments (signals 510) ACK(0) . . . ACK(I) to the content source 105. The content source 105 proceeds to transmit data packet P(I+1) (signal 515) towards mobile station 125.

Data packet P(I+1) is received, stored in memory 155, and transmitted by wireless switch 115 towards mobile station 125. However, the data packet P(I+1) is lost in transmission between the mobile station 125 and the wireless network 120. Content server 105 proceeds to transmit data packets P(I+2) . . . P(I+T) to the mobile station 125 (signal 520). Upon receipt of data packet P(I+T), the mobile station 125 transmits an acknowledgment. However, because P(I+1) was not received by the mobile station 125, the last contiguous data packet is P(I). Accordingly, mobile station 125 transmits ACK(1) (signal 525).

The ACK(I) is received by the wireless content switch 115 at downstream port 150b. Responsive thereto, the wireless content switch 115 detects that data packet P(I+1) is stored at the wireless switch and was not received by the mobile station 125. Accordingly, the wireless content switch 115 retransmits the data packet P(I+1) from memory 155 to mobile station 125 via downstream port 150b (signal 530). Additionally, the wireless content switch 115 withholds transmission of ACK(I) to the content server 105, thereby prevent invocation of congestion control and avoidance mechanisms. When the mobile station 125 receives data packet P(I+1), the mobile station 125 transmits an acknowledgment ACK(I+T) (signal 535) to the wireless content switch 115 which is forwarded to the content source 105.

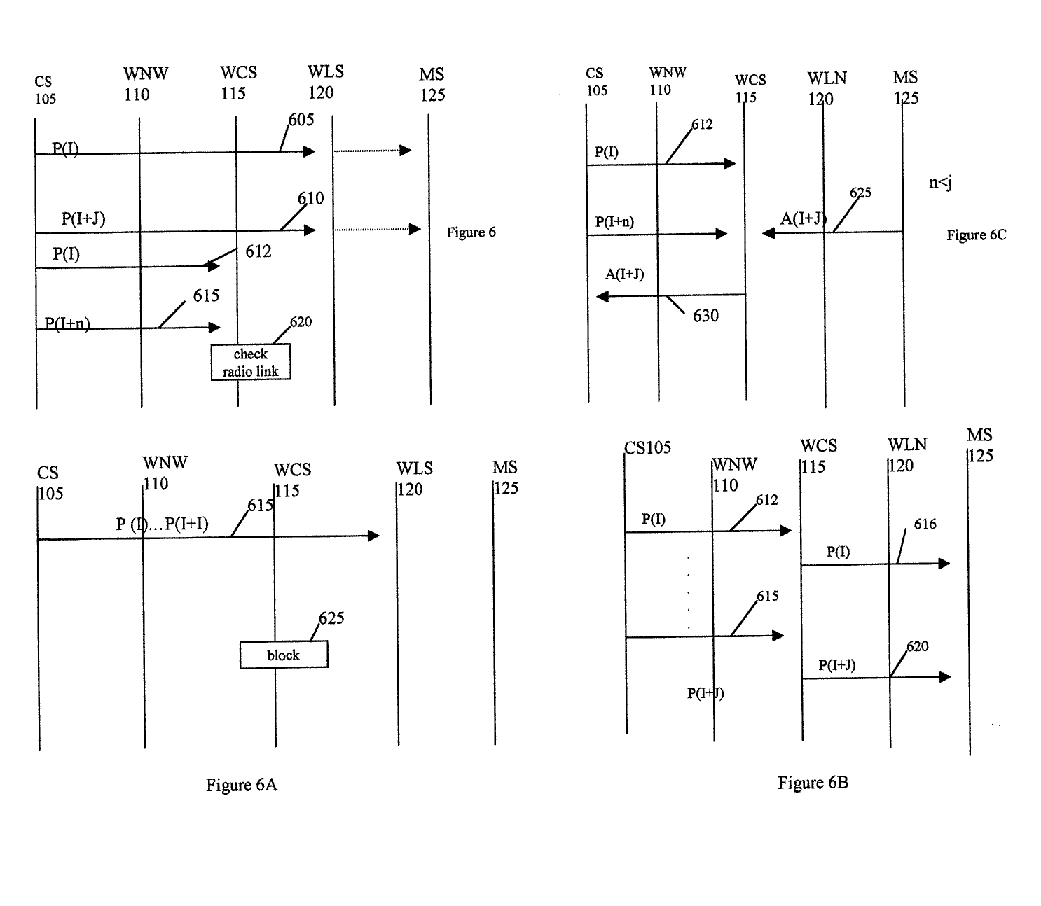

Referring now to FIG. 6, there is illustrated a signal flow diagram describing the operation of the wireless content switch 115, wherein lower ordered data packets are received by the wireless content switch 115 via upstream port 150a. Data packet P(I) through P(I+J) are transmitted from the content source 105 towards the mobile station 125 (signals 605, 610). After transmission of data packets P(1) to P(I+J) towards the mobile station 125, data packets P(I) . . . P(I+n), where n<=J, are again received at the wireless content switch (signals 612, 615) via the upstream port 105a.

The foregoing condition is indicative of a time out at the content source 105. The time out can either be caused by lost acknowledgments, a down radio connection between the wireless network 120 and the mobile station 125, or loss of data packets over the wireless network 120. Accordingly, the wireless content switch 115 examines the radio link and determines whether the radio link is up (action 620).

Referring now to FIG. 6A, there is illustrated a signal flow diagram describing the operation of the wireless content switch 115, wherein the wireless content switch 115 has detected that the radio link between the wireless network 120 and the mobile station 125 is down. Responsive to receipt of data packets P(I) . . . P(I+J) (signals 612, 615), the wireless content switch blocks (action 625) forward transmission of the data packets to the mobile station 125.

Referring now to FIG. 6B, there is illustrated a signal flow diagram describing the operation of the wireless content switch 115, wherein the radio link is determined to be operational. The wireless content switch 115 receives the data packets P(I) . . . P(I+J) (signal 612, 615) via upstream port 150a. The absence of any acknowledgment from the mobile station 125 is indicative of lost packets, P(I) . . . P(I+J) during the initial transmission (signals 605, 610). Accordingly, the wireless content switch 115 proceeds to retransmit the data packets P(I) . . . P(I+J) from memory 155 to the mobile station 125 (signals 616, 620) via downstream port 150b.

Referring now to FIG. 6C, there is illustrated a signal flow diagram describing the operation of the wireless content switch 115, wherein the radio link is determined to be operational. The wireless content switch 115 receives the data packets P(I) ...P(I+n) via upstream port 150a (signals 612, 615). However, the wireless content switch 115 receives an acknowledgment, ACK(I+J) , (signal 625) indicating receipt of each data packet until data packet P(I+J) via downstream port 150b. The foregoing is indicative of a lost acknowledgment. Accordingly, the wireless content switch 115 retransmits the acknowledgment (signal 630) via upstream port 150a to the content source 105. Transmission of the acknowledgment ACK(I+J) causes the content source to terminate transmission of the data packets prior to P(I+J).

Although the foregoing detailed description describes certain embodiments with a degree of specificity, it should be noted that the foregoing embodiments are by way of example, and are subject to modifications, substitutions, or alterations without departing from the spirit or scope of the invention. For example, one embodiment can be implemented as sets of instructions resident in a memory, such as memory 155, 170, 175, or 185. Those skilled in the art will recognize that physical storage of instructions physically changes the medium upon which it is stored electronically, magnetically, or chemically so that the medium carries computer readable information. Accordingly, the invention is only limited by the following claims, and equivalents thereof.

What is claimed is:

1. A wireless content switch for transmitting data packets, said wireless content switch comprising:
an upstream port for receiving one or more data packets;
a downstream port for transmitting the one or more data packets to a mobile station; and
memory for storing the one or more data packets responsive to receiving the data packets and for retrieving the one or more data packets for retransmission.

2. The wireless content switch of claim 1, further comprising:
a processing unit for executing a plurality of instructions; and
wherein the memory stores the plurality of executable instructions comprising:
determining whether one or more of the data packets are lost in a wireless network.

3. The wireless content switch of claim 2, wherein the executable instructions for determining whether one or more of the data packets are lost in the wireless network further comprises:
receiving a plurality of acknowledgments from the mobile station, wherein each acknowledgment comprises a particular data packet number; and
examining the acknowledgments to determine whether two or more of the acknowledgments comprise a same data packet number.

4. The wireless content switch of claim 3, wherein the plurality of instructions for determining whether one or more data packets are lost in the wireless network further comprises:
retransmitting at least one of the data packets, wherein at least two or more acknowledgments comprise a same data packet number.

5. The wireless content switch of claim 1, wherein the plurality of executable instructions further comprises:
determining whether one or more data packets are lost in a wireline network.

6. The wireless content switch of claim 5, wherein the instructions for determining whether one or more data packets are lost in the wireline network further comprises:
examining a packet number associated with one or more of the data packets.

7. The wireless content switch of claim 6, wherein the instructions for determining whether one or more packets are lost in the wireline network further comprises:
comparing the packet number associated with the one or more of the data packets with a second packet number; and
transmitting an acknowledgment to a content server wherein the packet number associated with the one or more data packets exceeds the second packet number by a predetermined threshold.

8. In a packet data network comprising a wired network, a wireless network, a method for transmitting data packets to a mobile station, said method comprising:
receiving one or more data packets from the wired network;
storing the one or more data packets until determination that the one or more data packets are received at a mobile station; and
transmitting the one or more data packets over the wireless data network to the mobile station.

9. The method of claim 8, further comprising:
determining whether one or more of the data packets are lost in the wireless network.

10. The method of claim 9, wherein determining whether one or more of the data packets are lost in the wireless network further comprises:
receiving a plurality of acknowledgments from the mobile station, wherein each acknowledgment comprises a particular data packet number; and
examining the acknowledgments to determine whether two or more of the acknowledgments comprise a same data packet number.

11. The method of claim 10, wherein determining whether one or more data packets are lost in the wireless network further comprises:
retransmitting at least one of the data packets, wherein at least two or more acknowledgments comprise a same data packet number.

12. The method of claim 8, further comprising:
determining whether one or more data packets are lost in a wireline network.

13. The method of claim 12, wherein determining whether one or more data packets are lost in the wireline network further comprises:
examining a packet number associated with one or more of the data packets.

14. The method of claim 13 wherein determining whether one or more packets are lost in the wireline network further comprises:
comparing the packet number associated with the one or more of the data packets with a second packet number; and
transmitting an acknowledgment to a content server wherein the packet number associated with the one or more data packets exceeds the second packet number by a predetermined threshold.

15. An article of manufacture for transmitting data packets to a mobile station in a packet data network comprising a wired network, a wireless network, and a wireless content switch connected therebetween, said article of manufacture comprising computer readable medium storing a plurality of instructions comprising:
receiving one or more data packets from the wired network;
storing the one or more data packets until determination that the one or more data packets are received at a mobile station; and
transmitting the one or more data packets over the wireless data network to the mobile station.

16. The article of manufacture of claim 15, wherein the plurality of instructions further comprises:
determining whether one or more of the data packets are lost in the wireless network.

17. The article of manufacture of claim 16, wherein the plurality of instructions for determining whether one or more of the data packets are lost in the wireless network further comprises:
receiving a plurality of acknowledgments from the mobile station, wherein each acknowledgment comprises a particular data packet number; and
examining the acknowledgments to determine whether two or more of the acknowledgments comprise a same data packet number.

18. The article of manufacture of claim 17, wherein the instructions for determining whether one or more data packets are lost in the wireless network further comprises:
retransmitting at least one of the data packets, wherein at least two or more acknowledgments comprise a same data packet number.

19. The article of manufacture of claim 15, wherein the plurality of instructions further comprises:
determining whether one or more data packets are lost in a wireline network.

20. The article of manufacture of claim 19, wherein the instructions for determining whether one or more data packets are lost in the wireline network further comprises:
examining a packet number associated with one or more of the data packets.

21. The article of manufacture of claim 20 wherein the instructions for determining whether one or more packets are lost in the wireline network further comprises:
comparing the packet number associated with the one or more of the data packets with a second packet number; and
transmitting an acknowledgment to a content server wherein the packet number associated with the one or more data packets exceeds the second packet number by a predetermined threshold.
